(19) United States
(12) Patent Application Publication
(10) Pub. No.: US 2024/0212374 A1
(43) Pub. Date: Jun. 27, 2024

(54) LIDAR POINT CLOUD SEGMENTATION METHOD, DEVICE, APPARATUS, AND STORAGE MEDIUM

(71) Applicant: THE CHINESE UNIVERSITY OF HONG KONG (SHENZHEN) FUTURE NETWORK OF INTELLIGENCE INSTITUTE, Shenzhen (CN)

(72) Inventors: Zhen Li, Shenzhen (CN); Xu Yan, Shenzhen (CN); Jiantao Gao, Shenzhen (CN); Chaoda Zheng, Shenzhen (CN); Ruimao Zhang, Shenzhen (CN); Shuguang Cui, Shenzhen (CN)

(21) Appl. No.: 18/602,007

(22) Filed: Mar. 11, 2024

Related U.S. Application Data
(63) Continuation of application No. PCT/CN2022/113162, filed on Aug. 17, 2022.

(30) Foreign Application Priority Data
Jul. 28, 2022 (CN) 202210894615.8

(51) Int. Cl. G06V 20/70; G06V 10/26; G06V 10/50; G06V 10/80

(52) U.S. Cl. CPC G06V 20/70; G06V 10/26; G06V 10/50; G06V 10/806

(57) ABSTRACT

The present disclosure provides a lidar point cloud segmentation method, device, apparatus, and storage medium. In the method, the three-dimensional point cloud and the two-dimensional image of the target scene are obtained, and multiple image blocks are obtained by performing block processing on the two-dimensional image; one image block is randomly selected from the multiple image blocks and is outputted to the preset two-dimensional feature extraction network to generate multi-scale two-dimensional features; the feature extraction is performed based on the three-dimensional point cloud to generate multi-scale three-dimensional features; the multi-scale three-dimensional and two-dimensional features are fused to obtain fused features; the fused features are distilled to obtain a single-modal semantic segmentation model. The three-dimensional point cloud is taken as the input of the single-modal semantic segmentation model for semantic discrimination to obtain a semantic segmentation label, thus, the target scene can be segmented based on the semantic segmentation label.

### CROSS-REFERENCE TO RELATED APPLICATIONS

The present application is a Continuation application of PCT Application No. PCT/CN2022/113162, filed on Aug. 17, 2022, which claims the priority of Chinese Invention Application No. 202210894615.8, filed on Jul. 28, 2022, the entire contents of which are hereby incorporated by reference.

### FIELD

The present invention relates to image technologies, and more particularly, to a lidar point cloud segmentation method, device, apparatus, and storage medium.

### BACKGROUND

A semantic segmentation algorithm plays an important role in the understanding of large-scale outdoor scenes and is widely used in autonomous driving and robotics. Over the past few years, researchers have put a lot of effort into using camera images or lidar point clouds to as inputs to understand natural scenes. However, these single-modal methods inevitably face challenges in complex environments due to the limitations of the sensors used. Although cameras can provide dense color information and fine-grained textures, but the cameras cannot provide accurate depth information and reliable in low-light conditions. In contrast, lidars reliably provide accurate and extensive depth information regardless of lighting variations, but captures only sparse and untextured data.

At present, the information of provided by the two complementary sensors, that is, cameras and lidars, can be improved by providing fusion strategy. However, the method of improving segmentation accuracy based on fusion strategy has the following inevitable limitations:
firstly, due to the different field of views (FOVs) between the camera and the lidar, a point-to-pixel mapping cannot be established for points outside the image plane. Often, the FOVs of the lidar and the camera overlap only in a small area, which greatly limits the application of fusion-based methods;
secondly, fusion-based methods consume more computing resources because both images and point clouds are being processed when the methods are executed, which puts a great burden on real-time applications.

### SUMMARY

Therefore, the present disclosure provides a lidar point cloud segmentation method, device, apparatus, and storage medium, aiming to solve the problem that the present point cloud data segmentation method consumes a lot of computing resources and has a low segmentation accuracy.

In the first aspect of the present disclosure, a lidar point cloud segmentation method is provided, including:
obtaining a three-dimensional point cloud and a two-dimensional image of a target scene, and performing block processing on the two-dimensional image to obtain multiple image blocks;
randomly selecting one image block from the multiple image blocks and outputting the selected image block to a preset two-dimensional feature extraction network to generate multi-scale two-dimensional features;
performing feature extraction using a preset three-dimensional feature extraction network based on the two-dimensional point cloud to generate multi-scale three-dimensional features;
fusing the multi-scale two-dimensional features and the multi-scale three-dimensional features to obtain fused features;
distilling the fused features with unidirectional modal preservation to obtain a single-modal semantic segmentation model; and
obtaining a three-dimensional point cloud of a scene to be segmented, inputting the three-dimensional point cloud into the single-modal semantic segmentation model for semantic discrimination to obtain a semantic segmentation label, and segmenting the target scene based on the semantic segmentation label.

In an embodiment, the preset two-dimensional feature extraction network includes at least a two-dimensional convolution encoder; the randomly selecting one image block from the multiple image blocks and outputting the selected image block to a preset two-dimensional feature extraction network to generate multi-scale two-dimensional features includes:
determining a target image block from the multiple image blocks using a random algorithm, and constructing a two-dimensional feature map based on the target image block; and
performing a two-dimensional convolution operation on the two-dimensional feature map through the two-dimensional convolution encoder based on different scales to obtain the multi-scale two-dimensional features.

In an embodiment, the preset two-dimensional feature extraction network further includes a full convolution decoder; after performing a two-dimensional convolution operation on the two-dimensional feature map through the two-dimensional convolution encoder based on different scales to obtain the multi-scale two-dimensional features, the method further includes:
extracting the two-dimensional features belonging to the last convolution layer in the two-dimensional convolution encoder from the multi-scale two-dimensional features;
sampling the two-dimensional features of the last convolution layer step by step using an up-sampling strategy through the full convolution decoder to obtain a decoding feature map; and
performing a convolution operation on the decoding feature map using the last convolution layer in the two-dimensional convolution encoder to obtain a new multi-scale two-dimensional feature.

In an embodiment, the preset three-dimensional feature extraction network includes at least a three-dimensional convolution encoder with sparse convolution construction; the performing feature extraction using a preset three-dimensional feature extraction network based on the two-dimensional point cloud to generate multi-scale three-dimensional features includes:
extracting non-hollow bodies from the three-dimensional point cloud through the three-dimensional convolution encoder, and performing a convolution operation on the non-hollow bodies to obtain the three-dimensional convolution features;
up-sampling on the three-dimensional convolution features using an up-sampling strategy to obtain decoding features; and
when the size of the sampled feature is the same as that of the original feature, stitching the three-dimensional convolution features and the decoding features to obtain the multi-scale three-dimensional features.

In an embodiment, after performing feature extraction using a preset three-dimensional feature extraction network based on the two-dimensional point cloud to generate multi-scale three-dimensional features, and before fusing the multi-scale two-dimensional features and the multi-scale three-dimensional features to obtain fused features, the method further includes:
adjusting resolutions of the multi-scale two-dimensional features to a resolution of the two-dimensional image using a deconvolution operation;
based on the adjusted multi-scale two-dimensional features, calculating a mapping relationship between the adjusted multi-scale two-dimensional features and the corresponding point cloud through a perspective projection method, and generating a point-to-pixel mapping relationship;
determining a corresponding two-dimensional truth value label based on the point-to-pixel mapping relationship;
constructing a point-to-voxel mapping relationship of each point cloud in the three-dimensional point cloud using a preset voxel function; and
according to the point-to-voxel mapping relationship, interpolating the multi-scale three-dimensional features by a random linear interpolation to obtain the three-dimensional features of each point cloud.

In an embodiment, the fusion of the multi-scale two-dimensional features and the multi-scale three-dimensional features to obtain fused features includes:
converting the three-dimensional features of the point cloud into two-dimensional features using a GRU-inspired fusion;
perceiving the three-dimensional features obtained by other convolution layers corresponding to the two-dimensional features using a multi-layer perception mechanism, calculating a difference between the two-dimensional feature and the three-dimensional feature, and stitching the two-dimensional feature with the corresponding two-dimensional feature in the decoding feature map; and
obtaining fused features based on the difference and a result of the stitching operation.

In an embodiment, the distilling of the fused features with unidirectional modal preservation to obtain a single-modal semantic segmentation model includes:
inputting the fused features and the converted two-dimensional features into a full connection layer of the dimensional feature extraction network in turn to obtain a corresponding semantic score;
determining a distillation loss based on the semantic score; and
according to the distillation loss, distilling the fused features with unidirectional modal preservation to obtain the single-modal semantic segmentation model.

In a second aspect of the present disclosure, a lidar point cloud segmentation device is provided, including:
an collection module, configured to obtain a three-dimensional point cloud and a two-dimensional image of a target scene, and process the two-dimensional image by block processing to obtain multiple image blocks;
a two-dimensional extraction module, configured to randomly select one image block from the multiple image blocks and output the selected image block to a preset two-dimensional feature extraction network to generate multi-scale two-dimensional features;
a three-dimensional extraction module, configured to perform feature extraction using a preset three-dimensional feature extraction network based on the three-dimensional point cloud to generate multi-scale three-dimensional features;
a fusion module, configured to fuse the multi-scale two-dimensional features and the multi-scale three-dimensional features to obtain fused features;
a model generation module, configured to distill the fused features with unidirectional modal preservation to obtain a single-modal semantic segmentation model; and
a segmentation module, configured to obtain the three-dimensional point cloud of a scene to be segmented, input the three-dimensional point cloud into the single-modal semantic segmentation model for semantic discrimination to obtain a semantic segmentation label, and segment the target scene based on the semantic segmentation label.

In an embodiment, the preset two-dimensional feature extraction network includes at least a two-dimensional convolution encoder, and the two-dimensional extraction module includes:
a construction unit, configured to determine a target image block from the multiple image blocks using a random algorithm, and construct a two-dimensional feature map based on the target image block; and
a first convolution unit, configured to perform a two-dimensional convolution operation on the two-dimensional feature map through the two-dimensional convolution encoder based on different scales to obtain the multi-scale two-dimensional features.

In an embodiment, the preset two-dimensional feature extraction network also includes a full convolution decoder, and the two-dimensional extraction module further includes a first decoding unit configured to:
extract the two-dimensional features belonging to a last convolution layer in the two-dimensional convolution encoder from the multi-scale two-dimensional features;
sample the two-dimensional features of the last convolution layer step by step using an up-sampling strategy through the full convolution decoder to obtain a decoding feature map; and
perform a convolution operation of the decoding feature map using the last convolution layer in the two-dimensional convolution encoder to obtain a new multi-scale two-dimensional feature.

In an embodiment, the preset three-dimensional feature extraction network includes at least a three-dimensional convolution encoder using sparse convolution construction, and the three-dimensional extraction module includes:
a second convolution unit, configured to extract non-hollow bodies in the three-dimensional point cloud through the three-dimensional convolution encoder, and performing a convolution operation on the non-hollow bodies to obtain the three-dimensional convolution features;
a second decoding unit, configured to up-sample the three-dimensional convolution features using an up-sampling strategy to obtain decoding features;
a stitching unit, configured to, when the size of the sampled feature is the same as that of the original feature, stitch the three-dimensional convolution features and the decoding features to obtain the multi-scale three-dimensional feature.

In an embodiment, the lidar point cloud segmentation device further includes an interpolation module configured to:
adjust resolutions of the multi-scale two-dimensional features to a resolution of the two-dimensional image using a deconvolution operation;
based on the adjusted multi-scale two-dimensional features, calculate a mapping relationship between the adjusted multi-scale two-dimensional features and the corresponding point cloud through a perspective projection method, and generate a point-to-pixel mapping relationship;
determine a corresponding two-dimensional truth value label based on the point-to-pixel mapping relationship;
construct a point-to-voxel mapping relationship of each point cloud in the three-dimensional point cloud using a preset voxel function; and
according to the point-to-voxel mapping relationship, interpolate the multi-scale three-dimensional features by a random linear interpolation to obtain the three-dimensional features of each point cloud.

In an embodiment, the fusion module includes:
a conversion unit configured to convert the three-dimensional features of the point cloud into two-dimensional features using a GRU-inspired fusion;
a calculating and stitching unit configured to perceive the three-dimensional features obtained by other convolution layers corresponding to the two-dimensional features using a multi-layer perception mechanism, calculating a difference between the two-dimensional feature and the three-dimensional feature and stitching the two-dimensional feature with the corresponding two-dimensional feature in the decoding feature map; and
a fusion unit configured to obtain fused features based on the difference and a result of the stitching operation.

In an embodiment, the segmentation module includes:
a semantic obtaining unit configured to input the fused features and the converted two-dimensional features into the full connection layer of the two-dimensional feature extraction network in turn to obtain a corresponding semantic score;
a determination unit configured to determine a distillation loss based on the semantic score; and
a distillation unit configured to distill the fused features with unidirectional modal preservation to obtain a single-modal semantic segmentation model.

In a third aspect of the present disclosure, an electronic apparatus is provided, the electronic apparatus has a memory, a processor, and a computer program stored in the memory and capable of running on the processor, wherein, when being executed by the processor, the computer program is capable of implementing each step of the above lidar point cloud segmentation method.

In a fourth embodiment of the present disclosure, a computer-readable storage medium is provided with a computer program stored thereon, wherein, when being executed by a processor, the computer program is capable of causing the processor to implement each step of the above lidar point cloud segmentation method.

In the present disclosure, the three-dimensional point cloud and the two-dimensional image of the target scene are obtained, and multiple image blocks are obtained by performing block processing on the two-dimensional image; one image block is randomly selected from the multiple image blocks and the selected image block is outputted to the preset two-dimensional feature extraction network to generate multi-scale two-dimensional features; the feature extraction using a preset three-dimensional feature extraction network is performed based on the three-dimensional point cloud to generate multi-scale three-dimensional features; the multi-scale three-dimensional features and the multi-scale two-dimensional features are fused to obtain fused features; the fused features are distilled with unidirectional modal preservation to obtain a single-modal semantic segmentation model; and a three-dimensional point cloud of a scene to be segmented is obtained and inputted into the single-modal semantic segmentation model for semantic discrimination to obtain a semantic segmentation label. The semantic segmentation label is sufficiently fused with the two-dimensional features and the three-dimensional point cloud can use the two-dimensional features to assist the three-dimensional point cloud to perform the semantic segmentation, which can effectively avoid the extra computing burden in practical applications compared with the methods based on fusion. Thus, the present disclosure can solve the problem that the existing point cloud segmentation solution consumes a lot of computing resources and has a low accuracy.

### BRIEF DESCRIPTION OF THE DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 provides a schematic diagram of a lidar point cloud segmentation method;

FIG. 2 is a schematic diagram of the lidar point cloud segmentation method in accordance with a first embodiment of the present disclosure;

FIG. 3 is a schematic diagram of the lidar point cloud segmentation method in accordance with a second embodiment of the present disclosure;

FIG. 4A is a schematic diagram showing a generation process of two-dimensional features of the present disclosure;

FIG. 4B is a schematic diagram showing a generation process of three-dimensional features of the present disclosure;

FIG. 5 is a schematic diagram showing a process of fusion and distilling of the present disclosure;

FIG. 6 is a schematic diagram of a lidar point cloud segmentation device in accordance with an embodiment of the present disclosure;

FIG. 7 is a schematic diagram of a lidar point cloud segmentation device in accordance with another embodiment of the present disclosure; and

FIG. 8 is a schematic diagram of an electronic apparatus in accordance with an embodiment of the present disclosure.

### DETAILED DESCRIPTION

In an existing semantic segmentation solution in which information captured by a camera and a lidar sensor are fused to achieve multi-modal data fusion for semantic segmentation, it is difficult to send the original camera image to the multi-modal channel because the original camera image is very large (e.g., the pixel resolution of the image is 1242×512). In the present disclosure, a lidar point cloud two-dimensional priors assisted semantic segmentation (2DPASS) is provided. This is a general training solution to facilitate presentation learning on point clouds. The 2DPASS algorithm makes full use of two-dimensional images with rich appearance in the training process, but does not require paired data as input in the inference stage. In an embodiment, the 2DPASS algorithm extracts richer semantic and structural information from multi-modal data using an assisted modal fusion module and a multi-scale fusion-to-single knowledge distillation (MSFSKD) module, which is then extracted into a pure three-dimensional network. Therefore, with the help of 2DPASS, the model can be significantly improved using only the point cloud input.

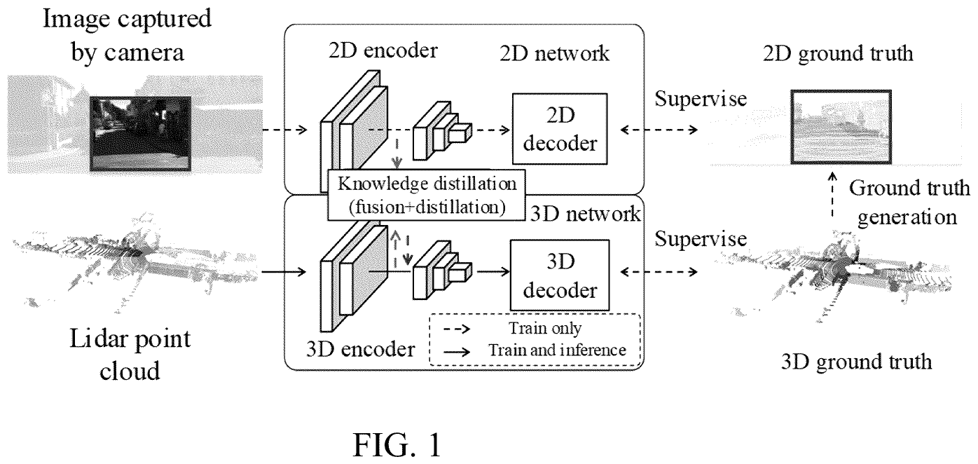

As shown in FIG. 1, a small block (pixel resolution 480×320) is randomly selected from the original camera image as two-dimensional input, which speeds up the training process without reducing the performance. Then, the cropped image block and the point cloud obtained by lidars are passed through an independent two-dimensional encoder and an independent three-dimensional encoder respectively to extract multi-scale features of the two main stems in parallel. Then, a multi-scale fusion into single knowledge distillation (MSFSKD) method is used to enhance the three-dimensional network with multi-modal features, that is, taking full advantage of the two-dimensional priori of texture and color perception while preserving the original three-dimensional specific knowledge. Finally, the two-dimensional features and the three-dimensional features at each scale are used to generate a semantic segmentation prediction supervised by pure three-dimensional labels. During the inference process, branches related to two-dimensional can be discarded, which effectively avoids additional computing burdens in practical applications compared with the existing fusion-based methods.

The terms “first”, “second”, “third”, and “fourth”, if any, in the specification and claims of the invention and in the drawings attached above are used to distinguish similar objects and need not be used to describe a particular order or sequence. It should be understood that the data thus used are interchangeable where appropriate so that the embodiments described here can be implemented in an order other than that illustrated or described here. Furthermore, the term “includes” or “has”, and any variation thereof, is intended to cover a non-exclusive inclusion. For example, a process, method, system, product or device comprising a series of steps or units need not be limited to those steps or units that are clearly listed. Instead, it may include other steps or units that are not clearly listed or are inherent to these processes, methods, products, or devices.

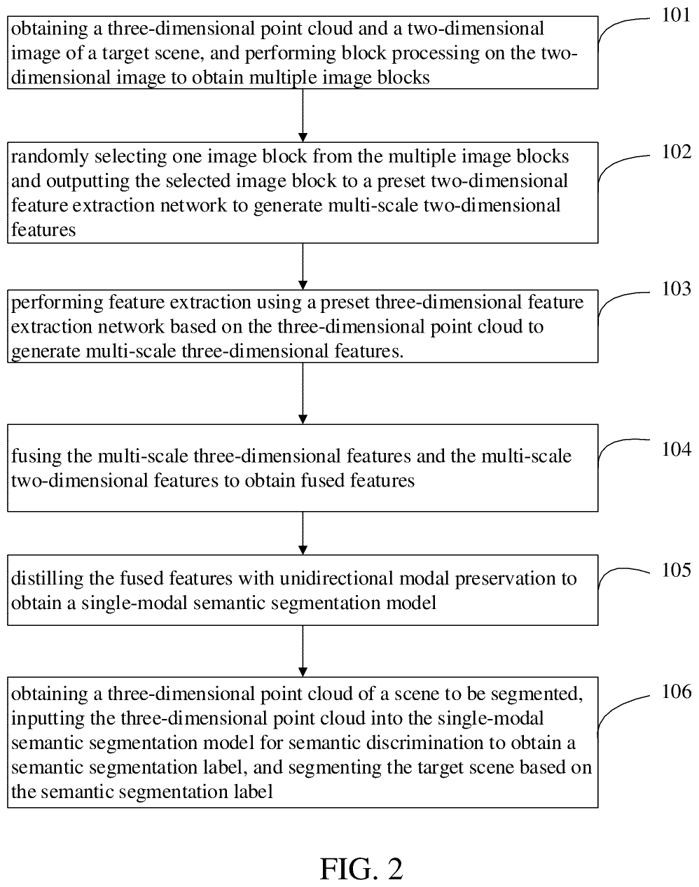

For ease of understanding, the specific process of the embodiment of the invention is described below. As shown in FIGS. 1 and 2, a lidar point cloud segmentation method in accordance with a first embodiment of the present disclosure includes steps as follows.

Step S101, obtaining a three-dimensional point cloud and a two-dimensional image of a target scene, and performing block processing on the two-dimensional image to obtain multiple image blocks.

In this embodiment, the three-dimensional point cloud and two-dimensional image can be obtained by a lidar acquisition device and an image acquisition device arranged on an autonomous vehicle or a terminal.

Furthermore, in the block processing of the two-dimensional image, the content of the two-dimensional image is identified by an image identification model, in which the environmental information and non-environmental information in the two-dimensional image can be identified by a scene depth, and a corresponding area of the two-dimensional image is labeled based on the identification result. The two-dimensional image is then segmented and extracted based on the label to obtain multiple image blocks.

Furthermore, the two-dimensional image can be divided into multiple blocks according to a preset pixel size to obtain the image blocks.

Step S102, randomly selecting one image block from the multiple image blocks and outputting the selected image block to a preset two-dimensional feature extraction network to generate multi-scale two-dimensional features.

In this step, the two-dimensional feature extraction network is a two-dimensional multi-scale feature encoder. A random algorithm is used to select one image block from multiple image blocks and input the selected image block into the two-dimensional multi-scale feature encoder. The two-dimensional multi-scale feature encoder extracts features from the image blocks at different scales to obtain the multi-scale two-dimensional features.

In this embodiment, the preset two-dimensional feature extraction network includes at least a two-dimensional convolution encoder; a target image block is determined using the random algorithm from multiple image blocks, and a two-dimensional feature map is constructed based on the target image block.

Through the two-dimensional convolution encoder, the two-dimensional convolution operation is performed on the two-dimensional feature map based on different scales to obtain the multi-scale two-dimensional features.

Step S103, performing feature extraction using a preset three-dimensional feature extraction network based on the three-dimensional point cloud to generate multi-scale three-dimensional features.

In this step, the three-dimensional feature extraction network is a unit convolution encoder. During the feature extraction, a non-hollow body in the three-dimensional point cloud is extracted using the three-dimensional convolution encoder, and the convolution operation is performed on the non-hollow body to obtain three-dimensional convolution features.

An up-sampling operation is performed on the three-dimensional convolution features by using an up-sampling strategy to obtain decoding features.

When the size of the sampled feature is the same as that of the original feature, stitching the three-dimensional convolution features and the decoding features to obtain the multi-scale three-dimensional features.

Step S104, fusing the multi-scale three-dimensional features and the multi-scale two-dimensional features to obtain fused features.

In this embodiment, the multi-scale three-dimensional features and the multi-scale two-dimensional features can be superposed and fused by percentage or by extracting features of different channels.

In practical applications, after a dimension reduction of the three-dimensional features, the three-dimensional features are perceived upward and the two-dimensional features are perceived downward through a multi-layer perception mechanism, and a similarity relationship between the three-dimensional features with reduced dimension and the perceived features is determined to select stitching.

Step S105, distilling the fused features with unidirectional modal preservation to obtain a single-modal semantic segmentation model.

Step S106, obtaining a three-dimensional point cloud of a scene to be segmented, inputting the three-dimensional point cloud into the single-modal semantic segmentation model for semantic discrimination to obtain a semantic segmentation label, and segmenting the target scene based on the semantic segmentation label.

In this embodiment, the fused features and the converted two-dimensional features are input to a full connection layer of the dimensional feature extraction network in turn to obtain a corresponding semantic score; a distillation loss is determined based on the semantic score; according to the distillation loss, the fused features are distilled with unidirectional modal preservation to obtain the semantic segmentation label. The target scene is then segmented based on the semantic segmentation label.

In the embodiment of the present disclosure, the three-dimensional point cloud and the two-dimensional image of the target scene are obtained, and the two-dimensional image is processed by block processing to obtain multiple image blocks. One image block is randomly selected from the multiple image blocks and the selected image block is output to the preset two-dimensional feature extraction network for feature extraction to generate the multi-scale two-dimensional features. The feature extraction is performed based on the three-dimensional point cloud using the preset three-dimensional feature extraction network to generate the multi-scale three-dimensional features. The multi-scale two-dimensional features and the multi-scale three-dimensional features are fused to obtain the fused features. The fused features are distilled with unidirectional modal preservation to obtain the single-modal semantic segmentation model. The three-dimensional point cloud is input to the single-modal semantic segmentation model for semantic discrimination to obtain the semantic segmentation label, and the target scene is segmented based on the semantic segmentation label. It solves the technical problems that the existing point cloud data segmentation solution consumes a lot of computing resources and has a low segmentation accuracy.

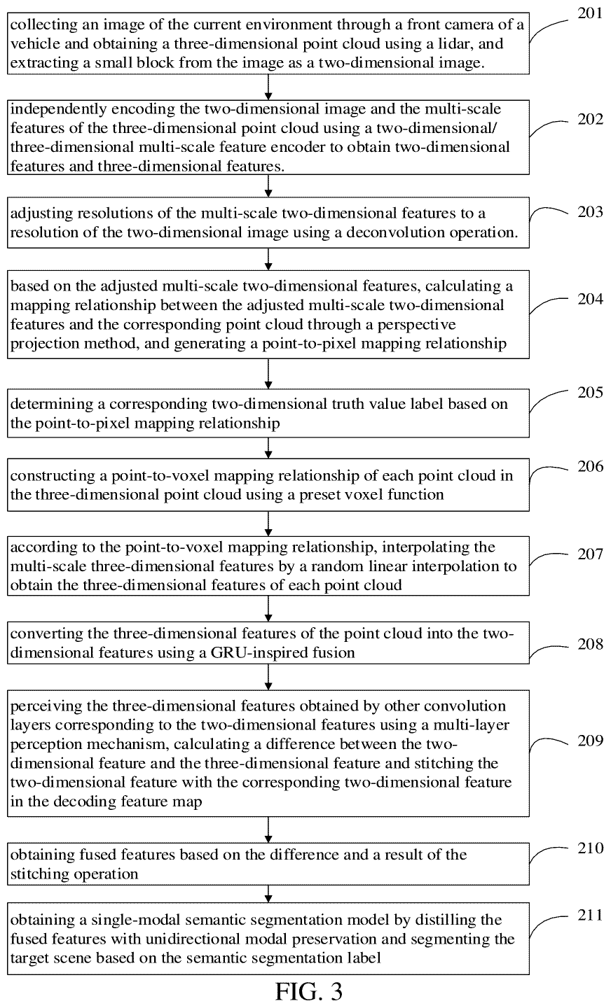

Please refer to FIGS. 1 and 3, a lidar point cloud segmentation method in accordance with a second embodiment is provided, including steps as follows.

Step S201, collecting an image of the current environment through a front camera of a vehicle and obtaining a three-dimensional point cloud using a lidar, and extracting a small block from the image as a two-dimensional image.

In this step, because the image captured by the camera of the vehicle is very large (for example, the pixel resolution of the image is 1242×512), it is difficult to send the original camera image to the multi-modal channel. Thus, a small block (pixel resolution thereof is 480×320) is randomly selected from the original camera image to be as a two-dimensional input, which speeds up the training process without reducing performance. Then, the cropped image block and the three-dimensional point cloud obtained by the lidar are passed through an independent two-dimensional encoder and an independent three-dimensional encoder respectively to extract the multi-scale features of the two main stems in parallel.

Step S202, independently encoding the two-dimensional image and the multi-scale features of the three-dimensional point cloud using a two-dimensional/three-dimensional multi-scale feature encoder to obtain two-dimensional features and three-dimensional features.

In an embodiment, a two-dimensional convolution ResNet34 encoder is used as a two-dimensional feature extraction network. For a three-dimensional feature extraction network, a sparse convolution is used to construct the three-dimensional network. One of the advantages of the sparse convolution is sparsity, and only non-hollow bodies are considered in the convolution operation. In an embodiment, a hierarchical encoder SPVCNN is designed, the design of the ResNet backbone is adopted on each scale, and the ReLU activation function is replaced by the Leaky ReLU activation function. In these two networks, feature maps L are extracted from different scales respectively to obtain two-dimensional features and three-dimensional features, namely,

$${\{ {F}_{l}^{2 D} \}}_{{l = 1}^{}}^{L} and {\{ {F}_{l}^{3 D} \}}_{l = 1}^{L}$$

In this embodiment, the preset two-dimensional feature extraction network includes at least a two-dimensional convolution encoder. The randomly-selecting one image block from multiple image blocks and outputting the selected image block to a preset two-dimensional feature extraction network for feature extraction to generate multi-scale two-dimensional features, including:
determining a target image block from the multiple image blocks using a random algorithm, and constructing a two-dimensional feature map based on the target image block; and
performing a two-dimensional convolution operation on the two-dimensional feature map through the two-dimensional convolution encoder to obtain the multi-scale two-dimensional features.

Furthermore, the preset two-dimensional feature extraction network also includes a full convolution decoder. After performing a two-dimensional convolution operation on the two-dimensional feature map through the two-dimensional convolution encoder to obtain the multi-scale two-dimensional features, the method further includes the following steps:
extracting two-dimensional features which belong to a last convolution layer in the two-dimensional convolution encoder from the multi-scale two-dimensional features;
sampling the two-dimensional features of the last convolution layer step by step using an up-sampling strategy through the full convolution decoder to obtain a decoding feature map; and
performing a convolution operation on the decoding feature map using the last convolution layer in the two-dimensional convolution encoder to obtain a new multi-scale two-dimensional feature.

Furthermore, the preset three-dimensional feature extraction network includes at least a three-dimensional convolution encoder using sparse convolution construction. The performing feature extraction using a preset three-dimensional feature extraction network based on the three-dimensional point cloud to generate multi-scale three-dimensional features includes:
extracting non-hollow bodies from the three-dimensional point cloud through the three-dimensional convolution encoder, and performing a convolution operation on the non-hollow bodies to obtain the three-dimensional convolution features;
up-sampling the three-dimensional convolution features using an up-sampling strategy to obtain decoding features; and
when the size of the sampled feature is the same as that of the original feature, stitching the three-dimensional convolution features and the decoding features to obtain the multi-scale three-dimensional features.

In practical applications, the above decoder can be a two-dimensional/three-dimensional prediction decoder. After the image of each scale and the features of the point cloud are processed, two specific modal prediction decoders are used respectively to restore the down-sampled feature map to the original size.

For the two-dimensional network, an FCN decoder can be used to up-sample the features of the last layer in the two-dimensional multi-scale feature encoder step by step.

In an embodiment, the feature map of the L-th layer Dₗ^{2D} can be obtained through the following formula:

Dₗ^{2D}=ConvBlock(DeConv(Dₗ₋₁^{2D})+F_{L-l+1}^{2D})

Wherein ConvBlock(⋅) and DeConv(⋅) are respectively a convolution block with a kernel size thereof being 3 and a deconvolution operation. The feature map of the first decoder is connected to the last encoder layer by hopping, namely: D_{L}^{2D}=F_{L}^{2D}. Finally, the feature map is transferred from the decoder through a linear classifier to obtain the semantic segmentation result of the two-dimensional image block.

For the three-dimensional network, a U-Net decoder which is used in previous methods is not adopted. Instead, features of different scales are up-sampled to the original sizes thereof, and the features are connected together before being input to a classifier. It is found that this structure enables better learning of hierarchical information and more efficient acquisition of predictions.

Step S203, adjusting resolutions of the multi-scale two-dimensional features to a resolution of the two-dimensional image using a deconvolution operation.

Step S204, based on the adjusted multi-scale two-dimensional features, calculating a mapping relationship between the adjusted multi-scale two-dimensional features and the corresponding point cloud through a perspective projection method, and generating a point-to-pixel mapping relationship.

Step S205, determining a corresponding two-dimensional truth value label based on the point-to-pixel mapping relationship.

Step S206, constructing a point-to-voxel mapping relationship of each point cloud in the three-dimensional point cloud using a preset voxel function.

Step S207, according to the point-to-voxel mapping relationship, interpolating the multi-scale three-dimensional features by a random linear interpolation to obtain the three-dimensional features of each point cloud.

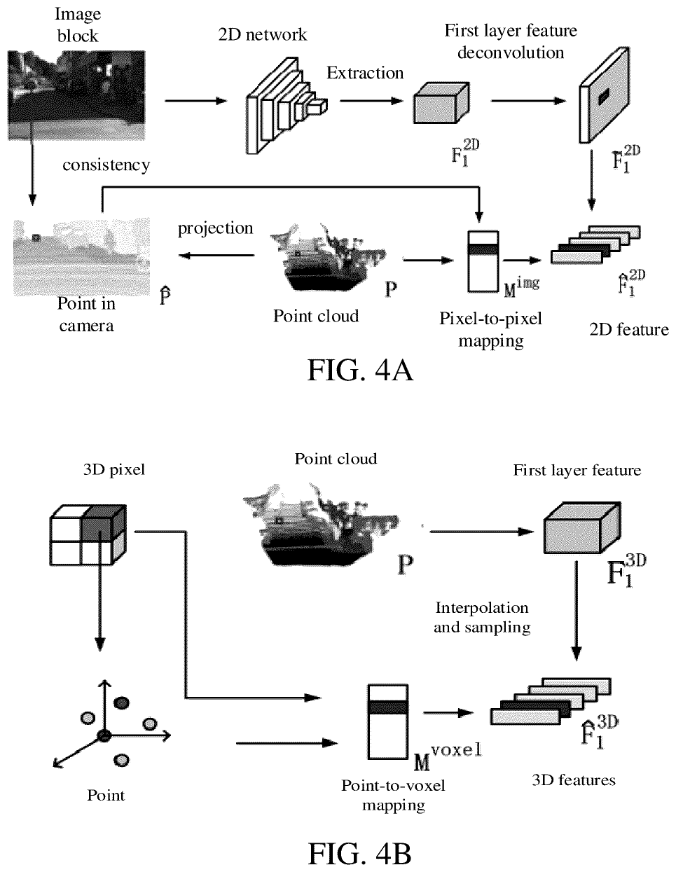

In this embodiment, because the two-dimensional features and the three-dimensional features are usually represented as pixels and points respectively, it is difficult to transfer information directly between the two modes. In this embodiment, the method aims to use the point-to-pixel correspondence to generate paired features of the two modes for further knowledge distillation. In previous multi-sensor methods, a whole image or a resized image is taken as input because the whole context usually provides a better segmentation result. In this embodiment, a more effective method is applied by cropping small image blocks. It proved that this method can greatly speed up the training phase and show the same effect as taking the whole image. The details of the generation of paired features in both modes are shown in FIGS. 4A and 4B. FIG. 4A shows the generation process of the two-dimensional features. Firstly, a point cloud is projected onto the image block, and a point-to-pixel (P2P) mapping is generated. Then, the two-dimensional feature map is converted into pointwise two-dimensional features based on the point-to-pixel mapping. FIG. 4B shows the generation process of the three-dimensional features. A point-to-voxel (P2V) mapping is easily obtained and voxel features are interpolated onto the point cloud.

In practical applications, the generation process of the two-dimensional features is shown in FIG. 4A. By cropping small blocks I∈R^{H×W×3} from the original image, multi-scale features can be extracted from hidden layers with different resolutions through the two-dimensional network. Taking the feature map of the i-th layer \hat{F}ₗ^{2D}= [symbol] ^{H}^{ₗ}^{×W}^{ₗ}^{×D}^{ₗ} as an example, a deconvolution operation is firstly performed to improve the resolution of the feature map to the original one \hat{F}ₗ^{2D}. Similar to the previous multi-sensor method, a perspective projection is used and a point-to-pixel mapping between the point cloud and the image is calculated. In an embodiment, for a lidar point cloud P={pᵢ}ᵢ₌₁^{N}∈R^{N×3}, each point pᵢ=(xᵢ,yᵢ,zᵢ)∈R^{3×4} of the three-dimensional point cloud is projected onto a point \tilde{p}ᵢ(uᵢ,vᵢ)∈R^{2×4} of an image plane with the following formula:

$${[ {u}_{i} , {v}_{i} , 1 ]}^{T} = \frac{1}{{z}_{i}} \times K \times T \times {[ {x}_{j} , {y}_{i} , {z}_{i} , 1 ]}^{T}$$

Wherein, K∈R^{3×4} and T∈R^{4×4} are an internal parameter matrix and an external parameter matrix of the camera respectively. K and T are provided directly in the KITTI dataset. Since the working frequencies of the lidar and the camera are different in NuScenes, a lidar frame of a time stamp tₗ is converted to a camera frame of a time stamp t_{c} through a global coordinate system. The external parameter matrix T provided by the NuScenes dataset is:

$$T = {T}_{camera ← {ego}_{{t}_{c}}} \times {T}_{{ego}_{{t}_{c}} ← global} \times {T}_{global ← {eqo}_{{t}_{l}}} \times {T}_{{ego}_{{t}_{l}} ← lidar}$$

The point-to-pixel mapping after projection is represented by the following formula:

M^{img}={(└vᵢ┘,└uᵢ┘)}ᵢ₌^{N}∈ [symbol] ^{N×2}

Wherein, └⋅┘ indicates the layer operation. According to the point-to-pixel mapping, if any pixel on the feature map is included in M^{img}, the pointwise two-dimensional feature F^{2D}∈ [symbol] ^{N}^{^{img}}^{×D}^{ₗ}, is extracted from the original feature map F^{2D}, wherein N^{img}<N indicates the number of points included in M^{img}.

The processing of the three-dimensional features is relatively simple, as shown in FIG. 4B. For the point cloud P={(xᵢ,yᵢ,zᵢ)}ᵢ₌₁^{N}, the point-to-voxel mapping of the L-th layer can be obtained with the following formula:

Mₗ^{voxel}={(└xᵢ/rᵢ┘,└yᵢ/rᵢ┘,└zᵢ/rᵢ┘)}ᵢ₌₁^{N}∈ [symbol] ^{N×3}

Wherein rᵢ is the resolution of voxelization of the l-th layer. Then, for the three-dimensional features \hat{F}ₗ^{3D}∈ [symbol] ^{N}^{ₗ}^{′×D}^{ₗ} from a sparse convolution layer, pointwise three-dimensional features \hat{F}ₗ^{3D}∈ [symbol] ^{N×D}^{ₗ} are obtained through 3-NN interpolation of the original feature map \hat{F}ₗ^{3D} by Mₗ^{voxel}. Finally, the points are filtered by discarding points outside the image's field of vision with the following formula:

\hat{F}ₗ^{3D}={fᵢ|fᵢ∈\tilde{F}ₗ^{3D},M_{i,1}^{img}≤H,M_{i,2}^{img}≤W}ᵢ₌₁^{N}∈ [symbol] ^{N}^{^{img}}^{×D}^{ₗ},

For two-dimensional ground-truth labels: since only two-dimensional images are provided, three-dimensional point labels are projected onto the corresponding image planes using the above point-to-pixel mapping to obtain two-dimensional ground-truths. After that, the projected two-dimensional ground truths can be used as the supervision of two-dimensional branches.

For feature correspondences: since the two-dimensional features and the three-dimensional features both use the point-to-pixel mapping, thus, the two-dimensional feature \hat{F}ₗ^{2D} and the three-dimensional feature \hat{F}ₗ^{3D} of the l-th layer have the same point N^{img} and the same point-to-pixel mapping.

Step S208, converting the three-dimensional features of the point cloud into the two-dimensional features using a GRU-inspired fusion.

For each scale, considering the difference between the two-dimensional feature and the three-dimensional feature due to different neural network backbones, it is invalid to directly fuse the original three-dimensional feature \hat{F}ₗ^{3D} into corresponding two-dimensional feature \hat{F}ₗ^{2D}. Therefore, inspired by the “reset gate” within the gate recurrent unit (GRU), \hat{F}ₗ^{3D} is converted into \hat{F}ₗ^{learner} at first and defined as a two-dimensional learner. Through a multi-layer perception (MLP) mechanism, the difference between the two features can be reduced. Then, \hat{F}ₗ^{learner} not only enters another MPL as well stitches with the two-dimensional feature \hat{F}ₗ^{2D} to obtain a fused feature \hat{F}ₗ^{2D3D}, but also can be connected back to the original three-dimensional feature by hopping, thus producing an enhanced three-dimensional feature \hat{F}ₗ^{3D}^{ₑ}. In addition, similar to the “update gate” design used in GRU, the final enhanced fused feature \hat{F}ₗ^{2D3D}^{ₑ} is obtained by the following formula:

\hat{F}ₗ^{2D3D}^{ₑ}=\hat{F}ₗ^{2D}+σ(MLP(\hat{F}ₗ^{2D3D}))⊙\hat{F}ₗ^{2D3D},

Wherein σ is a Sigmoid activation function.

Step S209, perceiving the three-dimensional features obtained by other convolution layers corresponding to the two-dimensional features using a multi-layer perception mechanism, calculating a difference between the two-dimensional feature and the three-dimensional feature and stitching the two-dimensional feature with the corresponding two-dimensional feature in the decoding feature map.

Step S210, obtaining fused features based on the difference and a result of the stitching operation.

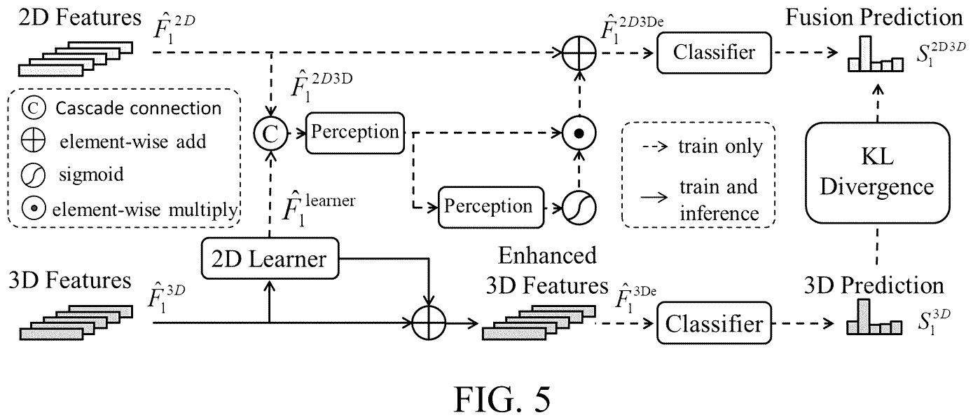

In this embodiment, the above fused features are obtained based on multi-scale fusion-single knowledge distillation (MSFSKD). MSFSKD is the key to 2DPASS, which aims to improve the three-dimensional representation of each scale by fusion and distillation using assisted two-dimensional priori. The design of the knowledge distillation (KD) of MSFSKD is partly inspired by XMUDA. However, XMUDA deals with KD in a simple cross-modal way, that is, outputs of two sets of single-modal features (i.e., the two-dimensional features or the three-dimensional features) are simply aligned, which inevitably pushes the two sets of modal features into an overlapping space thereof. Thus, this way actually discards the information of the specific modal, which is the key to multi-sensor segmentation. Although this problem can be mitigated by introducing an additional layer of segmented prediction, it is inherent in cross-modal distillation and thus results in biased predictions. Therefore, an MSFSKD module is provided, as shown in FIG. 5. Firstly, the image and the features of the point cloud are fused using an algorithm, and then the fused features of the point cloud are unidirectionally aligned. In the fusion-before and distillation-after method, the fusion preserves the complete information from the multi-modal data. In addition, unidirectional alignment ensures that the features of the enhanced point cloud after fusion does not discard any modal feature information.

Step S211, obtaining a single-modal semantic segmentation model by distilling the fused features with unidirectional modal preservation.

Step S212, obtaining the three-dimensional point cloud of a scene to be segmented, inputting the obtained three-dimensional point cloud into the single-modal semantic segmentation model for semantic discrimination to obtain a semantic segmentation label, and segmenting the target scene based on the semantic segmentation label.

In this embodiment, the fused features and the converted two-dimensional features are input into the full connection layer of the two-dimensional feature extraction network in turn to obtain the corresponding semantic score.

The distillation loss is determined based on the semantic score.

According to the distillation loss, the fused features are distilled with unidirectional modal preservation, and a single-modal semantic segmentation model is obtained.

Furthermore, the three-dimensional point cloud of the scene to be segmented is obtained and input into the single-modal semantic segmentation model for semantic discrimination, and the semantic segmentation label is obtained. The target scene is segmented based on the semantic segmentation label.

In practical applications, for the modality-preserving KD, although \hat{F}ₗ^{learner} is generated from pure three-dimensional features, it is also subject to a segmentation loss of a two-dimensional decoder that takes enhanced fused features \hat{F}ₗ^{2D3D}^{ₑ} as input. Like a residual difference between fusion and point features, the two-dimensional learner \hat{F}ₗ^{learner} can well prevent the distillation from polluting of specific modal information in \hat{F}ₗ^{3D} and realize the modality-preserving KD. Finally, two independent classifiers (full connection layer) are respectively applied in \hat{F}ₗ^{2D3D}^{ₑ} and \hat{F}ₗ^{3D}^{ₑ} to obtain the semantic fraction Sₗ^{2D3D} and Sₗ^{3D} and a KL divergence is selected as the distillation loss LₓM, as follows:

L_{xM}=D_{KL}(Sₗ^{2D3D}∥Sₗ^{3D}),

In the implementation, when calculating LₓM, Sₗ^{2D3D} is separated from the calculation diagram and Sₗ^{3D} is only pushed closer to Sₗ^{2D3D} to strengthen the unidirectional distillation.

As stated above, this knowledge distillation solution has the following advantages:
firstly, the two-dimensional leaner and fusion with single distillation provide rich texture information and structure regularization to enhance three-dimensional feature learning without discarding any specific modal information in three-dimensional feature;
secondly, the fusion branch is only used in the training phase; as a result, the enhanced model requires little additional computing resources in the inference process.

In this embodiment, a small block (pixel resolution thereof is 480×320) is randomly selected from the original camera image as a two-dimensional input, which speeds up the training process without reducing the performance. Then, the cropped image block and the lidar point cloud are passed through an independent two-dimensional encoder and a three-dimensional encoder respectively to extract the multi-scale features of the two main stems in parallel. Then, the multi-scale fusion into single knowledge distillation (MSFSKD) method is used to enhance the three-dimensional network with multi-modal features, that is, taking full advantage of the two-dimensional priori of texture and color perception while preserving the original three-dimensional specific knowledge. Finally, the two-dimensional features and the three-dimensional features at each scale are used to generate a semantic segmentation prediction supervised by pure three-dimensional labels. During the inference process, branches related to two-dimensional can be discarded, which effectively avoids additional computing burden in practical applications compared with the existing fusion-based methods. To solve the technical problems that the existing point cloud data segmentation solution consumes large computing resources and has a low segmentation accuracy.

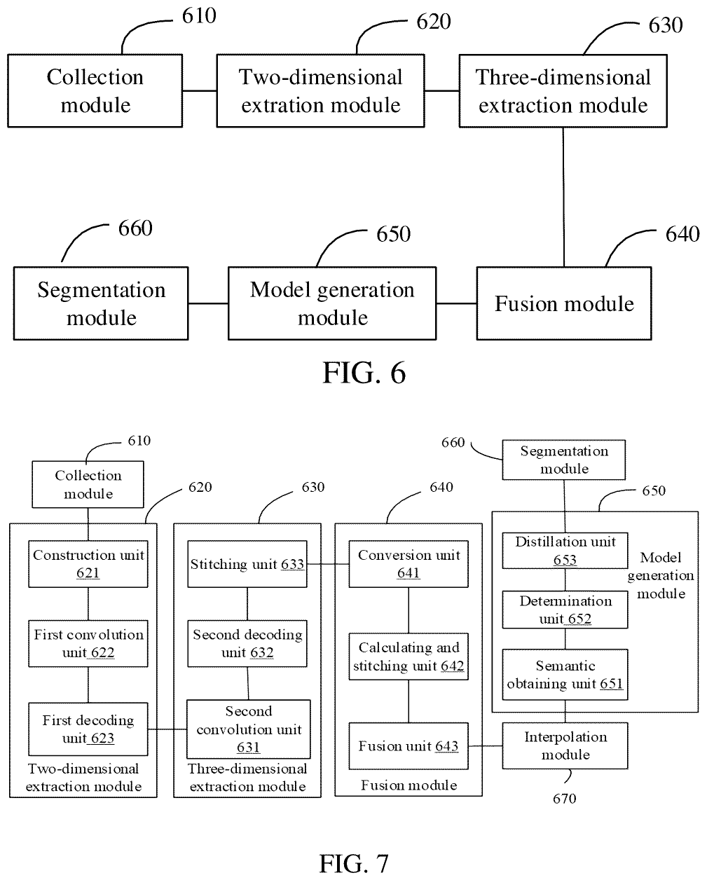

The lidar point cloud segmentation method in the embodiment of the invention is described above. A lidar point cloud segmentation device in the embodiment of the invention is described below. As shown in FIG. 6, the lidar point cloud segmentation device in an embodiment includes modules as follows.
a collection module 610, configured to obtain a three-dimensional point cloud and a two-dimensional image of a target scene, and process the two-dimensional image by block processing to obtain multiple image blocks;
a two-dimensional extraction module 620, configured to randomly select one image block from the multiple image blocks and output the selected image block to a preset two-dimensional feature extraction network to generate multi-scale two-dimensional features;
a three-dimensional extraction module 630, configured to perform feature extraction using a preset three-dimensional feature extraction network based on the three-dimensional point cloud to generate multi-scale three-dimensional features;
a fusion module 640, configured to fuse the multi-scale two-dimensional features and the multi-scale three-dimensional features to obtain fused features;
a model generation module 650, configured to distill the fused features with unidirectional modal preservation to obtain a single-modal semantic segmentation model; and
a segmentation module 660, configured to obtain the three-dimensional point cloud of a scene to be segmented, input the three-dimensional point cloud into the single-modal semantic segmentation model for semantic discrimination to obtain a semantic segmentation label, and segment the target scene based on the semantic segmentation label.

In the device provided in this embodiment, the two-dimensional images and the three-dimensional point clouds are fused after the two-dimensional images and the three-dimensional point clouds are coded independently, and the unidirectional modal distillation is used based on the fused features to obtain the single-modal semantic segmentation model. Based on the single-modal semantic segmentation model, the three-dimensional point cloud is used as the input for discrimination, and the semantic segmentation label is obtained. In this way, the obtained semantic segmentation label is fused with the two-dimensional feature and the three-dimensional feature, making full use of the two-dimensional features to assist the three-dimensional point cloud for semantic segmentation. Compared with the fusion-based method, the device of the embodiment of the present disclosure effectively avoids additional computing burden in practical applications, and solves the technical problems that the existing point cloud data segmentation consumes large computing resources and has a low segmentation accuracy.

Furthermore, please refer to FIG. 7, which is a detailed schematic diagram of each module of the lidar point cloud segmentation device.

In another embodiment, the preset two-dimensional feature extraction network includes at least a two-dimensional convolution encoder, and the two-dimensional extraction module 620 includes:
a construction unit 621, configured to determine a target image block from the multiple image blocks using a random algorithm, and construct a two-dimensional feature map based on the target image block; and
a first convolution unit 622, configured to perform a two-dimensional convolution operation on the two-dimensional feature map through the two-dimensional convolution encoder based on different scales to obtain the multi-scale two-dimensional features.

In another embodiment, the preset two-dimensional feature extraction network also includes a full convolution decoder, and the two-dimensional extraction module 620 further includes a first decoding unit 623. The first decoding unit 623 is configured to:
extract the two-dimensional features belonging to a last convolution layer in the two-dimensional convolution encoder from the multi-scale two-dimensional features;
sample the two-dimensional features of the last convolution layer step by step using an up-sampling strategy through the full convolution decoder to obtain a decoding feature map; and
perform a convolution operation of the decoding feature map using the last convolution layer in the two-dimensional convolution encoder to obtain a new multi-scale two-dimensional feature.

In the other embodiment, the preset three-dimensional feature extraction network includes at least a three-dimensional convolution encoder using sparse convolution construction. The three-dimensional extraction module 630 includes:
a second convolution unit 631, configured to extract non-hollow bodies in the three-dimensional point cloud through the three-dimensional convolution encoder, and performing a convolution operation on the non-hollow bodies to obtain the three-dimensional convolution features;
a second decoding unit 632, configured to up-sample the three-dimensional convolution features using an up-sampling strategy to obtain decoding features;
a stitching unit 633, configured to, when the size of the sampled feature is the same as that of the original feature, stitch the three-dimensional convolution features and the decoding features to obtain the multi-scale three-dimensional feature.

In another embodiment, the lidar point cloud segmentation device further includes an interpolation module 670 configured to:
adjust resolutions of the multi-scale two-dimensional features to a resolution of the two-dimensional image using a deconvolution operation;
based on the adjusted multi-scale two-dimensional features, calculate a mapping relationship between the adjusted multi-scale two-dimensional features and the corresponding point cloud through a perspective projection method, and generate a point-to-pixel mapping relationship;
determine a corresponding two-dimensional truth value label based on the point-to-pixel mapping relationship;
construct a point-to-voxel mapping relationship of each point cloud in the three-dimensional point cloud using a preset voxel function; and
according to the point-to-voxel mapping relationship, interpolate the multi-scale three-dimensional features by a random linear interpolation to obtain the three-dimensional features of each point cloud.

In another embodiment, the fusion module 640 includes:
a conversion unit 641 configured to convert the three-dimensional features of the point cloud into the two-dimensional features using a GRU-inspired fusion;
a calculating and stitching unit 642 configured to perceive the three-dimensional features obtained by other convolution layers corresponding to the two-dimensional features using a multi-layer perception mechanism, calculating a difference between two-dimensional feature and the three-dimensional feature and stitching the two-dimensional feature with the corresponding two-dimensional feature in the decoding feature map; and
a fusion unit 643 configured to obtain fused features based on the difference and a result of the stitching operation.

In another embodiment, the model generation module 650 includes:
a semantic obtaining unit 651 configured to input the fused features and the converted two-dimensional features into the full connection layer of the two-dimensional feature extraction network in turn to obtain a corresponding semantic score;
a determination unit 652 configured to determine a distillation loss based on the semantic score; and
a distillation unit 653 configured to distill the fused features with unidirectional modal preservation to obtain a single-modal semantic segmentation model.
with the above device, a small block (pixel resolution thereof is 480×320) is randomly selected from the original camera image as a two-dimensional input, which speeds up the training process without reducing the performance. Then, the cropped image block and the lidar point cloud are passed through an independent two-dimensional encoder and an independent three-dimensional encoder respectively to extract the multi-scale features of the two main stems in parallel. Then, the multi-scale fusion into single knowledge distillation (MSFSKD) method is used to enhance the three-dimensional network with multi-modal features, that is, taking full advantage of the two-dimensional priori of texture and color perception while preserving the original three-dimensional specific knowledge. Finally, the two-dimensional and the three-dimensional features at each scale are used to generate a semantic segmentation prediction supervised by pure three-dimensional labels. During the inference process, branches related to two-dimensional can be discarded, which effectively avoids additional computing burdens in practical applications compared with the existing fusion-based methods. To solve the technical problems that the existing point cloud data segmentation solution consumes large computing resources and has a low segmentation accuracy.

The lidar point cloud segmentation device in the embodiments shown in FIGS. 6 and 7 is described above from a perspective of modular function entity. The lidar point cloud segmentation device in the embodiments is described below from a perspective of hardware processing.

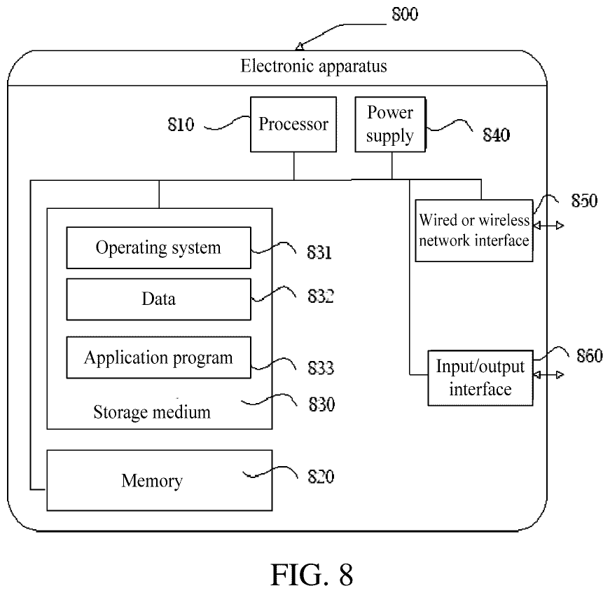

FIG. 8 is a schematic diagram of a hardware structure of an electronic apparatus. The electronic apparatus 800 may vary considerably due to different configurations or performance and may include one or more central processing units (CPUs) 810 (e.g. one or more processors), one or more memories 820, one or more storage media 830 for storing at least one applications 833 or for storing data 832 (such as one or more mass storage devices). Wherein the memory 820 and the storage medium 830 can be transient or persistent storage. Programs stored on the storage medium 830 may include one or more modules (not shown in the drawings), and each module may include a series of instruction operations on the electronic apparatus 800. Furthermore, the processor 810 can be set to communicate with the storage medium 830, performing a series of instructions in the storage medium 830 on the electronic apparatus 800.

The electronic apparatus 800 may also include one or more power supplies 840, one or more wired or wireless network interfaces 850, one or more input/output interfaces 860, and/or, one or more operating systems 831, such as WindowsServe, MacOSX, Unix, Linux, FreeBSD and so on. A person skilled in the art may understand that the structure of the electronic apparatus may include more or fewer components than those shown in the FIG. 8, or some components may be combined, or a different component deployment may be used.

The present disclosure further provides an electronic apparatus including a memory, a processor and a computer program stored in the memory and running on the processor. When being executed by the processor, the computer program implements each step in the lidar point cloud segmentation method provided by the above embodiments.

The present disclosure further provides a computer-readable storage medium. The computer-readable storage medium may be a non-volatile or a volatile computer-readable storage medium. The computer-readable storage medium stores at least one instruction or a computer program, and when being executed, the at least one instruction or computer program causes the computer to perform the steps of the lidar point cloud segmentation method provided by the above embodiments.

Those skilled in the art may clearly learn about that specific working processes of the system, device and unit described above may refer to the corresponding processes in the method embodiments and will not be elaborated, herein for convenient and brief description.

When the integrated unit is implemented in form of software functional unit and sold or used as an independent product, the integrated unit may be stored in a computer-readable storage medium. Based on such an understanding, the technical solutions of the disclosure substantially or parts making contributions to the conventional art or all or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The storage medium includes: various media capable of storing program codes such as a U disk, a mobile hard disk, a ROM, a RAM, a magnetic disk or an optical disk.

It is understandable that the above-mentioned technical features may be used in any combination without limitation. The above descriptions are only the embodiments of the present disclosure, which do not limit the scope of the present disclosure. Any equivalent structure or equivalent process transformation made by using the content of the description and drawings of the present disclosure, or directly or indirectly applied to other related technologies in the same way, all fields are included in the scope of patent protection of the present disclosure.

What is claimed is:

1. A lidar point cloud segmentation method, wherein the method comprises:
obtaining a three-dimensional point cloud and a two-dimensional image of a target scene, and performing block processing on the two-dimensional image to obtain multiple image blocks;
randomly selecting one image block from the multiple image blocks and outputting the selected image block to a preset two-dimensional feature extraction network to generate multi-scale two-dimensional features;
performing feature extraction using a preset three-dimensional feature extraction network based on the two-dimensional point cloud to generate multi-scale three-dimensional features;
fusing the multi-scale two-dimensional features and the multi-scale three-dimensional features to obtain fused features;
distilling the fused features with unidirectional modal preservation to obtain a single-modal semantic segmentation model; and
obtaining a three-dimensional point cloud of a scene to be segmented, inputting the three-dimensional point cloud into the single-modal semantic segmentation model for semantic discrimination to obtain a semantic segmentation label, and segmenting the target scene based on the semantic segmentation label.

2. The lidar point cloud segmentation method of claim 1, wherein the preset two-dimensional feature extraction network comprises at least a two-dimensional convolution encoder; the randomly selecting one image block from the multiple image blocks and outputting the selected image block to a preset two-dimensional feature extraction network to generate multi-scale two-dimensional features comprises:
determining a target image block from the multiple image blocks using a random algorithm, and constructing a two-dimensional feature map based on the target image block; and
performing a two-dimensional convolution operation on the two-dimensional feature map through the two-dimensional convolution encoder based on different scales to obtain the multi-scale two-dimensional features.

3. The lidar point cloud segmentation method of claim 2, wherein the preset two-dimensional feature extraction network further comprises a full convolution decoder; after the performing a two-dimensional convolution operation on the two-dimensional feature map through the two-dimensional convolution encoder based on different scales to obtain the multi-scale two-dimensional features, the method further comprises:
extracting the two-dimensional features belonging to the last convolution layer in the two-dimensional convolution encoder from the multi-scale two-dimensional features;
sampling the two-dimensional features of the last convolution layer step by step using an up-sampling strategy through the full convolution decoder to obtain a decoding feature map; and
performing a convolution operation on the decoding feature map using the last convolution layer in the two-dimensional convolution encoder to obtain a new multi-scale two-dimensional feature.

4. The lidar point cloud segmentation method of claim 1, wherein the preset three-dimensional feature extraction network comprises at least a three-dimensional convolution encoder with sparse convolution construction; the performing feature extraction using a preset three-dimensional feature extraction network based on the two-dimensional point cloud to generate multi-scale three-dimensional features comprises:
extracting non-hollow bodies from the three-dimensional point cloud through the three-dimensional convolution encoder, and performing a convolution operation on the non-hollow bodies to obtain the three-dimensional convolution features;
up-sampling on the three-dimensional convolution features using an up-sampling strategy to obtain decoding features; and
when the size of the sampled feature is the same as that of the original feature, stitching the three-dimensional convolution features and the decoding features to obtain the multi-scale three-dimensional features.

5. The lidar point cloud segmentation method of claim 1, wherein after the performing feature extraction using a preset three-dimensional feature extraction network based on the two-dimensional point cloud to generate multi-scale three-dimensional features, and before the fusing the multi-scale two-dimensional features and the multi-scale three-dimensional features to obtain fused features, the method further comprises:
adjusting resolutions of the multi-scale two-dimensional features to a resolution of the two-dimensional image using a deconvolution operation;
based on the adjusted multi-scale two-dimensional features, calculating a mapping relationship between the adjusted multi-scale two-dimensional features and the corresponding point cloud through a perspective projection method, and generating a point-to-pixel mapping relationship;
determining a corresponding two-dimensional truth value label based on the point-to-pixel mapping relationship;
constructing a point-to-voxel mapping relationship of each point cloud in the three-dimensional point cloud using a preset voxel function; and
according to the point-to-voxel mapping relationship, interpolating the multi-scale three-dimensional features by a random linear interpolation to obtain the three-dimensional features of each point cloud.

6. The lidar point cloud segmentation method of claim 5, wherein the fusing the multi-scale two-dimensional features and the multi-scale three-dimensional features to obtain fused features comprises:
converting the three-dimensional features of the point cloud into the two-dimensional features using a GRU-inspired fusion;
perceiving the three-dimensional features obtained by other convolution layers corresponding to the two-dimensional features using a multi-layer perception mechanism, calculating a difference between the two-dimensional feature and the three-dimensional feature and stitching the two-dimensional feature with the corresponding two-dimensional feature in the decoding feature map; and
obtaining fused features based on the difference and a result of the stitching operation.

7. The lidar point cloud segmentation method of claim 6, wherein the distilling the fused features with unidirectional modal preservation to obtain a single-modal semantic segmentation model comprises:
inputting the fused features and the converted two-dimensional features into a full connection layer of the dimensional feature extraction network in turn to obtain a corresponding semantic score;
determining a distillation loss based on the semantic score; and
according to the distillation loss, distilling the fused features with unidirectional modal preservation to obtain the single-modal semantic segmentation model.

8. A lidar point cloud segmentation device, wherein the device comprises:
an collection module, configured to obtain a three-dimensional point cloud and a two-dimensional image of a target scene, and process the two-dimensional image by block processing to obtain multiple image blocks;
a two-dimensional extraction module, configured to randomly select one image block from the multiple image blocks and output the selected image block to a preset two-dimensional feature extraction network to generate multi-scale two-dimensional features;
a three-dimensional extraction module, configured to perform feature extraction using a preset three-dimensional feature extraction network based on the three-dimensional point cloud to generate multi-scale three-dimensional features;
a fusion module, configured to fuse the multi-scale two-dimensional features and the multi-scale three-dimensional features to obtain fused features;
a model generation module, configured to distil the fused features with unidirectional modal preservation to obtain a single-modal semantic segmentation model; and
a segmentation module, configured to obtain the three-dimensional point cloud of a scene to be segmented, input the three-dimensional point cloud into the single-modal semantic segmentation model for semantic discrimination to obtain a semantic segmentation label, and segment the target scene based on the semantic segmentation label.

9. An electronic apparatus having a memory, a processor, and a computer program stored in the memory and capable of running on the processor, wherein, when being executed by the processor, the computer program is capable of implementing each step of the lidar point cloud segmentation method in claim 1.

10. An electronic apparatus having a memory, a processor, and a computer program stored in the memory and capable of running on the processor, wherein, when being executed by the processor, the computer program is capable of implementing each step of the lidar point cloud segmentation method in claim 2.

11. An electronic apparatus having a memory, a processor, and a computer program stored in the memory and capable of running on the processor, wherein, when being executed by the processor, the computer program is capable of implementing each step of the lidar point cloud segmentation method in claim 3.

12. An electronic apparatus having a memory, a processor, and a computer program stored in the memory and capable of running on the processor, wherein, when being executed by the processor, the computer program is capable of implementing each step of the lidar point cloud segmentation method in claim 4.

13. An electronic apparatus having a memory, a processor, and a computer program stored in the memory and capable of running on the processor, wherein, when being executed by the processor, the computer program is capable of implementing each step of the lidar point cloud segmentation method in claim 5.

14. An electronic apparatus having a memory, a processor, and a computer program stored in the memory and capable of running on the processor, wherein, when being executed by the processor, the computer program is capable of implementing each step of the lidar point cloud segmentation method in claim 6.

15. An electronic apparatus having a memory, a processor, and a computer program stored in the memory and capable of running on the processor, wherein, when being executed by the processor, the computer program is capable of implementing each step of the lidar point cloud segmentation method in claim 7.

16. A computer-readable storage medium with a computer program stored thereon, wherein, when being executed by a processor, the computer program is capable of causing the processor to implement each step of the lidar point cloud segmentation method in claim 1.

17. A computer-readable storage medium with a computer program stored thereon, wherein, when being executed by a processor, the computer program is capable of causing the processor to implement each step of the lidar point cloud segmentation method in claim 2.

18. A computer-readable storage medium with a computer program stored thereon, wherein, when being executed by a processor, the computer program is capable of causing the processor to implement each step of the lidar point cloud segmentation method in claim 3.

19. A computer-readable storage medium with a computer program stored thereon, wherein, when being executed by a processor, the computer program is capable of causing the processor to implement each step of the lidar point cloud segmentation method in claim 4.

20. A computer-readable storage medium with a computer program stored thereon, wherein, when being executed by a processor, the computer program is capable of causing the processor to implement each step of the lidar point cloud segmentation method in claim 5.
